(19) United States
(12) Patent Application Publication
(10) Pub. No.: US 2012/0200236 A1
(43) Pub. Date: Aug. 9, 2012

(54) Table lamp having ash-alerting and ash-extinguishing functions

(75) Inventor: Wen-Hung Huang, Tucheng City (TW)

(73) Assignee: Hannspree, Inc., Taipei County (TW)

(21) Appl. No.: 13/067,222

(22) Filed: May 18, 2011

(30) Foreign Application Priority Data
Feb. 9, 2011 (CN) 201110036187.7

(51) Int. Cl. H05B 37/02

(52) U.S. Cl. 315/362

(57) ABSTRACT

A table lamp having ash-alerting and ash-extinguishing functions includes a base, an arm pivotally connected with the base, a lighting lamp connected with the arm, a heat sensor, a warning light, and a control circuit. The base is, on top surface thereof, recessed with an accommodating chamber. The lighting lamp can, along with pivoting of the arm, cover the accommodating chamber. The control circuit is electrically connected with the heat sensor and the warning light, and is able to activate, selectively, the warning light based on a temperature detected by the heat sensor. Therefore, without a user have to pay much attention on whether cigarette butts or ash has been extinguished or not so as to assure avoiding a fire accident.

### BACKGROUND OF THE INVENTION

1. Field of the Invention

The present invention relates to a table lamp, and more particularly, to a table lamp having ash-alerting and ash-extinguishing functions.

2. Description of Related Art

Table lamps are common electric appliances indispensable for daily life, such as in offices, schools or others. With the rapid development in technologies, and human living quality is improved consequently. Conventional table lamps only have a single function, for ornamentation or for lighting purpose. Accordingly, the conventional table lamps cannot fully satisfy demands of modern people, and as a result, hardly increase product revenue.

For the occasion of small offices or home offices (SOHO), people working around the clock often smoke cigarettes at their work desk. They, however, would need an ashtray for collecting ash or cigarette butts, causing lots of inconvenience. Besides, unless particularly cautious, one can hardly perceive whether the ash or cigarette butts are completely extinguished or stubbed out. Fire disasters are often resulted from incomplete stubbed-out cigarettes, and cause great losses of lives and property.

In order to be more convenient for living nowadays, a table lamp having multi-functions, according to the present invention, has been developed after continuing research.

### SUMMARY OF THE INVENTION

An object of the present invention is to provide a table lamp so as to provide additionally, other than the lighting function of the conventional table lamp, an ash-alerting function, and even more, an ash-extinguishing function for lowering possibilities of fire disasters.

To achieve the above-mentioned object, a table lamp having ash-alerting and ash-extinguishing functions, according to the present invention, comprises a lighting lamp, an arm, a base, a heat sensor, a warning light, and a control circuit. One end of the arm connects to the lighting lamp and the other end pivotally connected to the base so as to define a pivoting axis, supporting the lighting lamp. Further, the base is recessed, on top surface thereof, with an accommodating chamber. Therefore, the lighting lamp can, along with pivoting of the arm, cover the accommodating chamber.

According to the present invention, the heat sensor is situated inside the accommodating chamber, and the warning light is fixed at the base. The control circuit is electrically connected with the heat sensor and the warning light, and can be activated, selectively, the warning light based on a temperature detected by the heat sensor.

Through the above-mentioned design, even if a user drops cigarette butts or ash into the accommodating chamber, which serves as an ashtray, there is no need for the user to pay much attention on whether or not the cigarette butts or ash has been fully extinguished so as to avoid a risk of fire. That is to say, through display of the warning light, the user can easily perceive a status of the waste contained in the accommodating chamber. Or even the warning light may adopt a flash bulb so as to strengthen a warning effect. Besides, by pivoting the arm, the lighting lamp can cover the accommodating chamber such that oxygen supplied from outside can be cut off, and this will assure safety.

According to the present invention, it is not to particularly limit the mode of the warning light in response to the detected temperature in order to activate the control circuit. For example, the warning light is lit immediately after a specific temperature is reached, or the warning light is to be activated only after a temperature detected by the heat sensor is greater than the specific temperature and that the temperature lasts continuously for a certain time period.

The table lamp, according to the present invention, may further comprise a detent mechanism which is electrically connected with the control circuit, and that the arm is biasingly engaged with a torsion spring. The detent mechanism is governed by the control circuit for selectively engaging with the arm so as to stop pivoting of the arm or to release a state of engagement. Therefore, different levels of security measure can be obtained by setting various conditions. For example, one may set to disengage the arm from the detent mechanism so as to extinguish ash or cigarette automatically, so long as the temperature detected by the heat sensor is greater than a specific temperature and that the temperature lasts continuously for a certain time period.

The arm may include a ratchet wheel, and that the detent mechanism may include a pawl for selectively engaging with the ratchet wheel so as to constitute a one-way limiting mechanism. This will facilitate setting the lighting lamp at a desired angular position.

Further, according to the present invention, the warning light may relate to an LED (light emitting diode) light. The warning light is not limited geometrically, for example, the warning light may have a ring appearance surrounding the accommodating chamber such that one can readily perceive the subject matter to be alerted. In addition, the lighting lamp may be pivotally arranged on the arm so as to provide a flexible adjustment to the direction of illumination.

Other objects, advantages, and novel features of the present invention will become more apparent from the following detailed descriptions when taken in conjunction with the accompanying drawings.

### BRIEF DESCRIPTION OF THE DRAWINGS

FIG. 1 is a perspective view illustrating a table lamp according to the present invention;

FIG. 2 is a cross-sectional view illustrating the table lamp, according to the present invention, in a state of use; and

FIG. 3 is a cross-sectional view illustrating the table lamp, according to the present invention, during ash extinguishment.

### DETAILED DESCRIPTION OF THE PREFERRED EMBODIMENTS

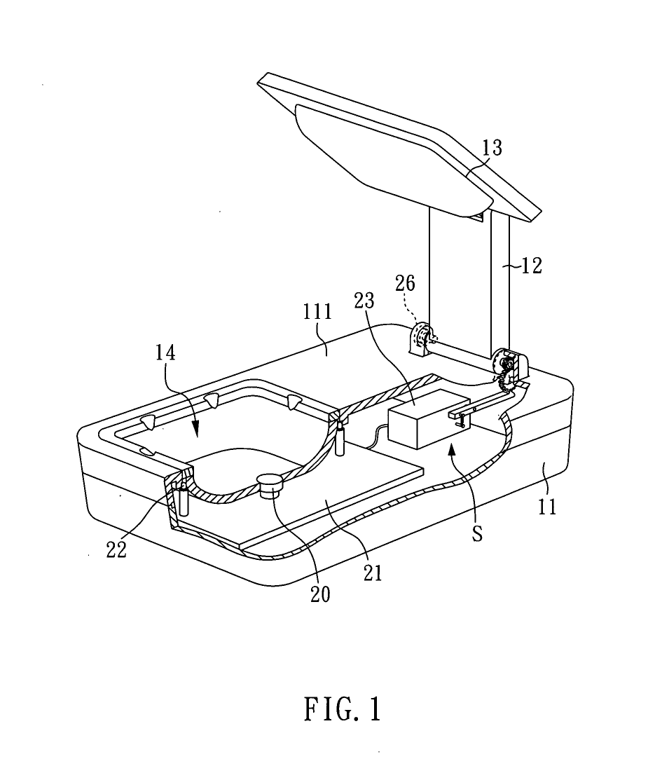

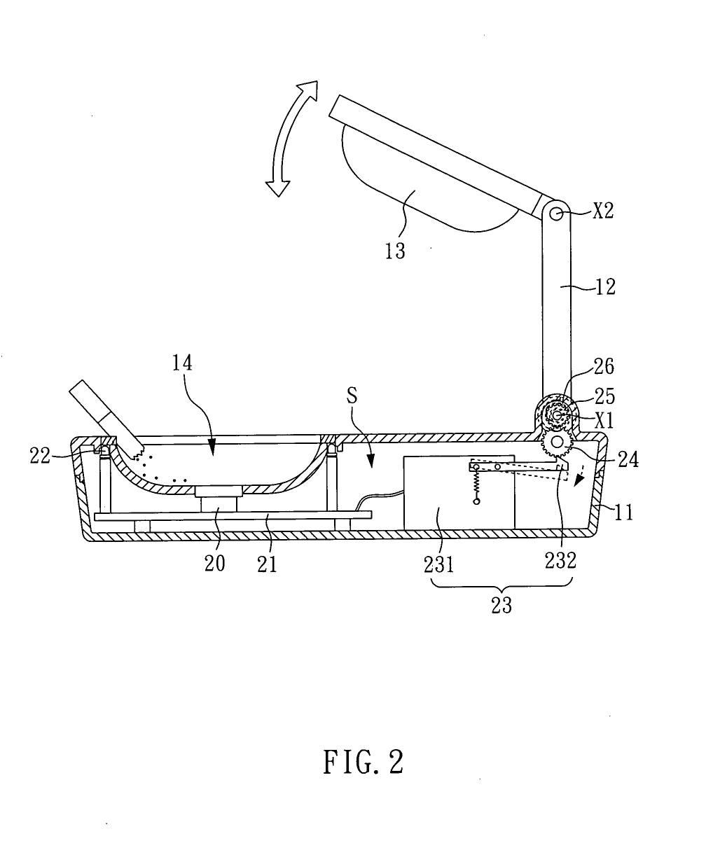

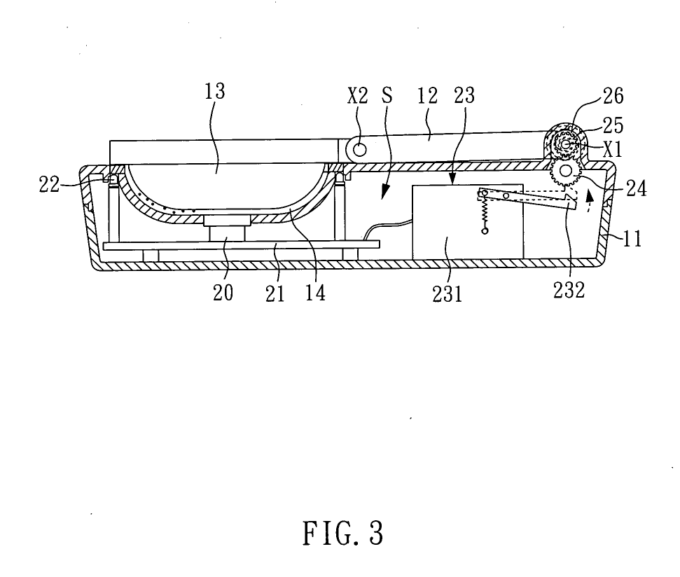

Referring to FIG. 1, a perspective view illustrating a table lamp according to the present invention, FIG. 2, a cross-sectional view illustrating the table lamp in a state of use, and FIG. 3, a cross-sectional view illustrating the table lamp during ash extinguishment, the table lamp having ash-alerting and ash-extinguishing functions comprises a base 11, an arm 12, a lighting lamp 13, a heat sensor 20, a control circuit 21, a warning light 22, and a detent mechanism 23. An internal space S is defined inside of the base 11, where the arm 12 is pivotally connected with a top surface 111 of the base 11 such that the arm 12 can be pivoted about a pivoting axis X1. Also, the lighting lamp 13 is pivotally connected with the arm 12 such that the lighting lamp 13 can be pivoted about another pivoting axis X2.

The top surface 111 of the base 11 is recessed with an accommodating chamber 14 for receiving the lighting lamp 13. In addition to the function of accommodation, the accommodating chamber 14 also serves as an ashtray for collecting ash or cigarette butts. The control circuit 21 is situated in the internal space S. The heat sensor 20, situated inside the accommodating chamber 14, is electrically connected with the control circuit 21 so as to transmit thermal data thereto.

The warning light 22 is fixed at the base 11, with part of which located inside the internal space S of the base 11, and part of which exposed to the top surface 111 of the base 11. The warning light 22 is also electrically connected with the control circuit 21 so as to illuminate under control thereof. According to the present embodiment, the warning light 22 is an LED light, having a ring appearance, surrounding the accommodating chamber 14.

Referring to FIG. 1, a ratchet wheel 24 and a speed-reduction gear 25, which are engaged with each other, at the opposite end to the arm 12 and the lighting lamp 13 are connected with each other. The speed-reduction gear 25 and the pivoting axis X1 are coaxially arranged, where in the present embodiment the pivoting axis X1 and the other pivoting axis X2 are parallel with each other. Because the speed-reduction gear 25 is subject to biasing engagement with a torsion spring 26, the arm 12 tends to pivot downward, in a direction that the lighting lamp 13 moves toward and is received in the accommodating chamber 14.

A detent mechanism 23 includes a control box 231 and a pawl 232, where the control box 231 and the control circuit 21 are electrically connected with each other, and the pawl 232 is pivotally arranged at the control box 231 such that the pawl 232 can be engaged, under control, with the ratchet wheel 24 selectively.

The control circuit 21 is designed in such a manner that it can activate the warning light 22 based on a temperature detected by the heat sensor 20. Operation of the table lamp, according to the present embodiment, is exemplified as follows:

When using an ordinary lighting function, where the lighting lamp 13 has been properly received in the accommodating chamber 14, one can exert force, directly, to pivot the arm 12 to a position of specific angle, as shown in FIG. 2. This can be easily accomplished by a one-way limiting mechanism constituted by the pawl 232 and the ratchet wheel 24.

During use of the table lamp, according to the present invention, in case a cigarette butt or ash is dropped into the accommodating chamber 14, the heat sensor 20 will feedback thermal data to the control circuit 21 in accordance with setting of the control circuit 21. Either the warning light 22 is illuminated immediately after a specific temperature is reached, or the warning light 22 is to be illuminated only after the specific temperature has been satisfied continuously for a certain time period.

In view of above description, it is understood that the table lamp, according to the present invention, can remind the user about information of hazardous materials (cigarette butts or ash), which may cause a fire accident, being kept in the accommodating chamber 14. Further, the control circuit 21 may be set to control the detent mechanism 23 to pivot the pawl 232 after a specific time period (may not be the same as that controlled for illumination). As long as the pawl 232 moves and disengages from the ratchet wheel 24 of the arm 12, the arm 12 will pivot automatically due to the bias of the torsion spring 26, and as such, the lighting lamp 13 is received in the accommodating chamber 14. In other words, the accommodating chamber 14 is covered and enclosed, turning into a sealed space. As a result, the cigarette butts or ash will be self extinguished due to lack of oxygen and that the purpose of ash extinguishment can be reached, see FIG. 3.

Although the present invention has been explained in relation to its preferred embodiments, it is to be understood that many other possible modifications and variations can be made without departing from the scope of the invention as hereinafter claimed.

What is claimed is:

1. A table lamp having ash-alerting and ash-extinguishing functions, comprising:
a lighting lamp;
an arm connected with the lighting lamp;
a base pivotally connected with the arm, wherein a top surface on the base, recessed with an accommodating chamber such that the lighting lamp can, along with pivoting of the arm, covers the accommodating chamber;
a heat sensor situated inside the accommodating chamber;
a warning light fixed at the base; and
a control circuit electrically connected with the heat sensor and the warning light, and being able to activate, selectively, the warning light based on a temperature detected by the heat sensor.

2. The table lamp as claimed in claim 1, further comprising a detent mechanism electrically connected with the control circuit, and the arm being biasingly engaged with a torsion spring such that the detent mechanism being governed for selectively engaging with the arm so as to stop pivoting of the arm.

3. The table lamp as claimed in claim 2, wherein the arm includes a ratchet wheel, and the detent mechanism includes a pawl for selectively engaging with the ratchet wheel.

4. The table lamp as claimed in claim 2, wherein the detent mechanism disengages from the arm so long as a temperature detected by the heat sensor is greater than a specific temperature and lasts continuously for a certain time period.

5. The table lamp as claimed in claim 1, wherein the warning light relates to an LED light.

6. The table lamp as claimed in claim 1, wherein the warning light has a ring appearance surrounding the accommodating chamber.

7. The table lamp as claimed in claim 1, wherein the lighting lamp is pivotally arranged on the arm.

8. The table lamp as claimed in claim 1, wherein the warning light is activated only after a temperature detected by the heat sensor is greater than a specific temperature and lasts continuously for a certain time period.
